(19) United States
(12) Patent Application Publication
(10) Pub. No.: US 2026/0166770 A1
(43) Pub. Date: Jun. 18, 2026

(54) INDUSTRIAL SLICER DEVICE, INDUSTRIAL SLICER AND METHOD FOR A SLICING OF OBJECTS

(71) Applicant: Schindler Holding GmbH & Co. KG, Plüderhausen (DE)

(72) Inventor: Bernhard KRAUS, Aalen – Dewangen (DE)

(21) Appl. No.: 19/424,367

(22) Filed: Dec. 18, 2025

(30) Foreign Application Priority Data
Dec. 18, 2024 (DE) 10 2024 138 735.1

(51) Int. Cl. B26D 7/02; B26D 3/28; B26D 7/01

(52) U.S. Cl. CPC B26D 7/02; B26D 3/28; B26D 2007/011

(57) ABSTRACT

The invention is based on an industrial slicer device having a holding and/or positioning unit at least for a holding and/or positioning of an object to be sliced relative to a separating unit that is capable of dividing the object into a plurality of slices, wherein the holding and/or positioning unit comprises a plurality of claw elements configured, in order to generate a claw force holding the object at the holding and/or positioning unit, to pierce a surface of the object and to penetrate into the object.

It is proposed that the holding and/or positioning unit comprises at least one claw carrier element, which is translationally and/or rotationally deflectable relative to a base of the holding and/or positioning unit, on the surface of which several of the claw elements are arranged, and/or which forms several of the claw elements integrally, wherein a claw direction at least of a portion of these claw elements of the claw carrier element runs at an angle to a main extension plane of the claw carrier element.

### CROSS-REFERENCE TO RELATED APPLICATION

As a U.S. follow-up application, this application is based on and claims priority to German patent application DE 10 2024 138 735.1, filed on Dec. 18, 2024, the contents of which are incorporated herein by reference.

### PRIOR ART

The invention concerns an industrial slicer device, an industrial slicer and a method for a slicing of objects.

Industrial food product slicer devices, having a holding and/or positioning unit at least for a holding and/or positioning of an object to be cut into slices relative to a separating unit that is capable of dividing the object into a plurality of slices, wherein the holding and/or positioning unit comprises a plurality of claw elements configured, in order to generate a claw force holding the object at the holding and/or positioning unit, to pierce a surface of the object and to penetrate into the object, have already been proposed.

The objective of the invention is in particular to provide a generic device having advantageous properties with regard to a holding of the objects, preferably with regard to a reduction of an object residue after slicing has taken place. The objective is achieved according to the invention.

### ADVANTAGES OF THE INVENTION

The invention is based on an industrial slicer device, in particular an industrial food product slicer device, having a holding and/or positioning unit at least for a holding and/or positioning of an object to be sliced, preferably of a food product to be cut into slices such as for example a cheese product, a sausage product, a meat product, a fish product or a bakery product, relative to a separating unit that is capable of dividing the object into a plurality of slices, wherein the holding and/or positioning unit comprises a plurality of claw elements configured, in order to generate a claw force holding the object at the holding and/or positioning unit, to pierce a surface of the object and to penetrate into the object.

It is proposed that the holding and/or positioning unit comprises at least one claw carrier element, which is translationally and/or rotationally deflectable relative to a base of the holding and/or positioning unit, which is in particular realized in an at least substantially planar manner, on the surface of which several of the claw elements are arranged, preferably in a position-fixed and orientation-fixed manner, and/or which forms several of the claw elements integrally, preferably monolithically, wherein a claw direction at least of a portion of these claw elements of the claw carrier element runs at an angle to a main extension plane of the claw carrier element. As a result, advantageous holding of the object relative to the separating unit is achievable. Advantageously, a yield, in particular a number of slices per sliced/cut object, can be maximized. It is advantageously possible, in particular in the case of food-product objects, to reduce waste of food products, in particular in that smaller/shorter end pieces can be obtained. As a result, a yield per object can advantageously be improved. In particular in the case of expensive food products or in the case of large plants cutting many kilometers of cheese or sausage every day, even small differences in end-piece size are of great importance. By means of the invention, it is advantageously possible to achieve a comparatively high claw force with a comparatively small depth of penetration into the object. Advantageously, the increase in yield can be achieved at the same time with high operational safety, in particular in that by means of the holding and/or positioning unit according to the invention, a risk of unintentionally losing the object can be kept low despite the small penetration depth. Advantageously, the implementation according to the invention of the holding and/or positioning unit allows reliable, reproducible and/or simple discarding of the end pieces.

An industrial slicer device is preferably at least one component of a specialized machine or plant, in particular of an industrial slicer that is configured for cutting objects into uniform slices or sections in an automated and precise manner in large quantities and at high speed. Industrial slicer devices can be used in various industrial fields, for example in the processing of plastics, wood or metal. However, the present invention preferably concerns an industrial slicer device for dividing food products, in particular cheese products, sausage products and their vegetarian/vegan substitutes, meat products, fish or fish products and/or bakery products. Industrial slicer devices are preferably designed for continuous operation in industrial production environments. Industrial slicer devices are realized substantially different from household cutting machines, such as for example bread slicing machines, and/or from sausage slicing machines, such as can be found in the charcuterie trade, etc. Industrial slicer devices are preferably made of easily cleanable and/or wear-resistant materials, such as for example non-rusting metals, in particular in order to ensure a high level of hygiene and/or a high level of safety. The holding and/or positioning unit is in particular configured to contact the object directly. Objects held by the holding and/or positioning unit preferably follow all movements of the holding and/or positioning unit as long as there is a holding contact with the object. “Configured” is in particular to mean specifically programmed, designed and/or equipped. By an object being configured for a certain function is in particular to be understood that the object fulfills and/or carries out this certain function in at least one application state and/or operation state.

The separating unit is in particular realized separately and/or differently from the holding and/or positioning unit. The separating unit in particular constitutes a further industrial slicer device of the industrial slicer, which is realized separately from the industrial slicer device described herein. Alternatively, however, it is also conceivable that the separating unit is an integral component of the industrial slicer device described herein. The separating unit may comprise different blade units or cutting heads, for example one or more circular knives, one or more spiral knives, in particular having variable radii, one or more shearing heads, one or more knife blades, or one or more band saw units. A slice is in particular a thin, flat section of an object, which has been produced by cutting or dividing the object. A claw element is preferably a physical component which operates by shape and function in a manner similar to a claw or similar to a hook. In particular, the claw element generates a claw force when interacting with an object clawed by the claw element. The claw force generated by the claw element, by which the object is held at the holding and/or positioning unit, is preferably greater than a weight force acting on the object at least in the horizontal state. In particular, the holding and/or positioning unit has three or more, preferably five or more, advantageously seven or more, preferably ten or more and particularly preferably 20 or more claw elements. In particular, the holding and/or positioning unit has less than a hundred, preferably less than 50 claw elements. Alternatively, however, numbers outside the aforementioned limits are also conceivable. The claw elements are in particular designed for the purpose of holding and precisely positioning the object by penetrating into the surface of the object. The claw elements are preferably designed such that their free ends are sharp and/or pointed enough to penetrate into the material of the object. The piercing preferably generates a direct mechanical connection between the claw elements and the object.

The claw force produced by the penetration of the claw elements into the object preferably ensures that the object remains firmly fixed at the holding or positioning unit, in particular even if the holding and/or positioning unit is moved. This fixing preferably prevents movements or slipping of the object during subsequent processes, such as for example slicing or transporting. The claw force typically acts orthogonally and/or obliquely relative to the surface of the object in order to avoid a slipping or a loosening of the object. The claw force is preferably generated by a kind of gripping and clamping effect of the claw elements. The claw carrier element is preferably a planarly implemented component serving as a carrier for the claw elements. The claw carrier element in particular provides a stable platform on which the claw elements are arranged. The claw carrier element preferably has a largely planar surface. The planar surface in particular forms a contact surface for the pierced surface of the object. The claw elements are arranged so as to be at least substantially distributed evenly on the planar surface of the claw carrier element. Positions and orientations of the claw elements on the claw carrier element are preferably unchangeable, in particular in order to ensure constant functionality. The claw carrier element is preferably linearly movable relative to the base of the holding and/or positioning unit along one or several axis/axes. The claw carrier element is preferably displaceable relative to the base of the holding and/or positioning unit. Alternatively or additionally, the claw carrier element can be rotated and/or pivoted relative to the base of the holding and/or positioning unit, for example around a rotation axis that projects perpendicularly from the planar surface. It is conceivable that the claw carrier element is only linearly displaceable, is only pivotable, is only rotatable or is capable of carrying out a combination of translational and rotational movements. The base in particular realizes a stable reference point from which the claw carrier element carries out its movements. The base is preferably fixedly connected with a frame of a machine comprising the industrial slicer device, in particular of the industrial slicer, or with the working environment. The claw elements may be mounted, for example screwed on, welded on, glued on, etc. to the claw carrier element, or may be realized directly by the claw carrier element. “Integrally” is in particular to mean connected by material bonding, such as for example by a welding process and/or gluing process, etc., and particularly advantageously molded on, such as by a production from a casting and/or by a production in a sheet-metal punch-bending process.

A “main extension plane” of a structural unit is in particular to mean a plane which is parallel to a largest side surface of a smallest imaginary cuboid just still completely enclosing the structural unit, and in particular runs through the center point of the cuboid. The main extension plane of the claw carrier element is a main extension plane of the surface on which the claw elements are fastened or realized. The main extension plane of the claw carrier element is a main extension plane of the surface surrounding the claw elements. The main extension plane of the claw carrier element is parallel to the surface surrounding the claw elements. The claw direction is preferably the orientation of the claw elements with respect to a plane or a structure on which they are fastened, i. e. in particular with respect to the claw carrier element/the surface of the claw carrier element. The claw direction preferably indicates in which direction a force penetrating the surface of the object is exerted by the claw elements and/or in which direction the claw elements act during the gripping, penetration or holding of the object. The claw direction is in particular the direction of the claw element in which its tip or wedge points. The angled claw direction is preferably not perpendicular to the surface of the claw carrier element and/or to the main extension plane of the claw carrier element. The angled claw direction is preferably not parallel to the surface of the claw carrier element and/or to the main extension plane of the claw carrier element. Preferably, the claw direction is oriented at a fixed angle or at an angle that is variable along the claw element relative to the main extension plane of the claw carrier element/the surface of the claw carrier element that surrounds the claw elements. The angle in particular has an influence on how deep the claw elements penetrate into the material of the object (the steeper relative to the main extension plane, the deeper the penetration) and/or how stable the object is held (the less deep the penetration, the less stable the holding). In order to obtain an end piece that is as short as possible, in particular an optimum balance between penetration depth and stable holding is sought. If the main extension plane of the claw carrier element is assumed to be horizontal, an angled claw direction may mean that the claw elements point at a downwards angle. Alternatively or additionally, the claw elements may point at an angle to the left, downwards to the left, to the right or downwards to the right. As a result, the force is exerted in such a way that the object is simultaneously fixed and slightly pressed downwards, which ensures stability. The angle of an angled claw element is in particular an angle between a main extension plane of the claw element and the main extension plane of the claw carrier element. Preferably, all claw elements of the slicer device are configured to penetrate into the same surface of the object/to interact with only a single side of the object.

Furthermore, it is proposed that at least one of the claw elements of the claw carrier element permanently protrudes by at least 5 mm, preferably by at least 6 mm, preferentially by at least 8 mm perpendicularly beyond the surface of the claw carrier element that surrounds the claw element. This advantageously allows achieving a favorable holding force, which is in particular sufficient for the functions of the holding and/or positioning unit. Advantageously, a large number of claw elements per area can be accommodated on the claw carrier element.

Preferably, all claw elements of the claw carrier element permanently protrude by at least 4 mm, preferably by at least 6 mm, and preferentially by at least 8 mm perpendicularly beyond the surface of the claw carrier element that surrounds all claw elements. The perpendicular protrusion is in particular formed by a farthest perpendicular/orthogonal distance of a point of a claw element from the surface of the claw carrier element.

It is moreover proposed that none of the claw elements of the claw carrier element protrudes by more than 10 mm, preferably by more than 8 mm, perpendicularly beyond the surface of the claw carrier element that surrounds the claw element. In this way, particularly short object end pieces are achievable, which in particular allows saving of costs and food waste. The contour length of the claw elements in a cross section may be greater than the perpendicular protrusion of the claw elements. For example, a contour length of approximately 10 mm at an angle of 60° will result in a perpendicular protrusion of approximately 7.6 mm. In this exemplary case, the perpendicular penetration depth is thus 7.6 mm, while the total penetration length (oblique penetration depth) is then 10 mm.

It is further proposed that main extension planes of the claw elements of the claw carrier element are oblique with respect to the main extension plane of the claw carrier element. In this way, advantageously a small perpendicular penetration depth with at the same time a sufficiently high claw force/holding force for holding and/or positioning the object is achievable. The main extension planes of the claw elements may partly extend parallel to one another or may all extend parallel to one another. For example, two groups of claw elements are conceivable, with respective main extension planes extending parallel to one another within the groups, whereas their main extension planes are different, for example extend in opposed directions to one another. The two groups of claw elements could then each be arranged on different claw carrier elements which are movable with respect to one another. It is furthermore also conceivable that a large portion of the main extension planes of the claw elements are not parallel to one another (for example a ring arrangement of the claw elements or a spiral arrangement of the claw elements). “Oblique” is in particular different from parallel and different from perpendicular.

It is additionally proposed that angles between the main extension planes of the claw elements of the claw carrier element and the main extension plane of the claw carrier element, and/or angles between the claw directions of the claw elements of the claw carrier element and the main extension plane of the claw carrier element, are smaller than 70°, preferably smaller than 60°; and/or that angles between the main extension planes of the claw elements of the claw carrier element and the main extension plane of the claw carrier element, and/or angles between the claw directions of the claw elements of the claw carrier element and the main extension plane of the claw carrier element are greater than 20°, preferably greater than 30°. This advantageously allows achieving a sufficient claw effect with at the same time a perpendicular penetration depth that is as small as possible.

It is furthermore proposed that the claw elements are arranged on the claw carrier element in several rows which are parallel to one another, and/or in several columns which are parallel to one another. In this way, a number of claw elements per area on the claw carrier element can advantageously be optimized. Moreover, advantageously a simple implementation is achievable. Moreover, simple re-dimensioning of the claw carrier element is advantageously achievable.

Advantageously, a particularly high number of claw elements can be accommodated on a claw carrier element. Herein the claw elements of a row or of a column may be interlaced with one another (like in a saw blade), that is they may in particular be equipped with tips pointing alternately in mutually opposed directions. In this way, advantageously an increase in a holding force with respect to lateral shear forces is achievable. In particular if spiral knives are used as a separating unit, a horizontal and a vertical component of a cutting force may be produced, such that it may be very advantageous, in particular in the case of spiral knives, if a claw element, preferably a holding and/or positioning unit (a collet), can absorb both force components.

Beyond this it is proposed that the claw elements are arranged on the claw carrier element in a spiral pattern, in a ring pattern, or in several spiral and/or ring patterns, which are preferably concentric with respect to one another. In this way, advantageous properties with regard to a compactness and/or with regard to a producible holding force of the claw carrier element are achievable. The tips of the claw elements that are arranged in a ring-shaped or spiral-shaped manner in each case point essentially in the direction or counter to the direction of the progression of the ring shape or of the spiral shape.

If the claw carrier element is supported so as to be—in particular only—translationally movable only parallel to a main extension plane of the claw carrier element, it is advantageously possible to provide a simple construction.

Advantageously, clamping-in of the object is achievable. If the claw carrier element is supported so as to be translationally movable only parallel to the main extension plane of the claw carrier element, the claw carrier element is not rotationally movable. In particular, the claw carrier element is supported so as to be translationally movable in the direction in which the claw elements are angled relative to a vertical. If therefore the claw elements are bent downwards, the claw carrier element is in such a case only movable downwards and upwards, not forwards or rearwards and not to any of the two sides. However, it is also conceivable that the claw carrier element is translationally movable in other directions than the bending direction of the claw elements, for example if the claw elements are bent slightly sideways. If the holding and/or positioning unit comprises a further claw carrier element, the further claw carrier element is preferably likewise supported so as to be translationally movable parallel or only parallel to the main extension plane of the claw carrier element and/or to a main extension plane of the further claw carrier element. Preferably, the two claw carrier elements are in such a case supported so as to be translationally movable towards each other (closing and/or squeezing direction) and away from each other (opening and/or releasing direction).

Alternatively or additionally, it is proposed that the claw carrier element is supported so as to be, in particular only, rotationally movable around a pivot axis that runs at least substantially parallel to a main extension plane of the claw carrier element. In this way, advantageously a compact implementation is achievable.

Advantageously, a gripping of the object can be optimized. If the claw carrier element is supported so as to be only pivotable, the claw carrier element is not translationally movable. If the holding and/or positioning unit comprises a further claw carrier element, the further claw carrier element is preferably likewise supported so as to be translationally movable pivotably or only pivotably relative to the main extension plane of the claw carrier element and/or to a main extension plane of the further claw carrier element. In particular, the pivotable claw carrier elements are supported pivotably in such a way that the surfaces of the claw carrier elements, in particular the claw elements, can be pivoted towards an object surface or away from an object surface.

Alternatively or additionally, it is also proposed that the claw carrier element is supported so as to be rotationally movable, in particular only, around a rotation axis that runs at least substantially perpendicular to a main extension plane of the claw carrier element. In this way, advantageously a compact implementation is achievable. Advantageously, a gripping of the object can be optimized. If the claw carrier element is supported so as to be only rotationally movable, the claw carrier element is not translationally movable. If the holding and/or positioning unit comprises a further claw carrier element, the further claw carrier element is preferably likewise supported so as to be rotationally movable (only or additionally) around the rotation axis or around a further rotation axis at least substantially perpendicular to a main extension plane of the further claw carrier element. In particular, the rotationally movable claw carrier elements are supported rotatably in such a way that the surfaces of the claw carrier elements, in particular the claw elements, can be moved on circular or spiral paths in a plane that is parallel to the object surface. In general, it is also possible to combine several of the following types of movement: translational and parallel displacement relative to the main extension plane of the claw carrier elements, pivoting around a pivot axis that runs parallel to the main extension plane of the claw carrier elements, and rotating around a rotation axis that runs perpendicular to the main extension plane of the claw carrier elements.

Beyond this, it is proposed that the holding and/or positioning unit comprises at least one further claw carrier element, which is translationally and/or rotationally deflectable relative to the base of the holding and/or positioning unit, which is in particular realized in an at least substantially planar manner, on the surface of which several of the claw elements are arranged, preferably in a position-fixed and orientation-fixed manner, and/or which forms several of the claw elements integrally, wherein a claw direction at least of a portion of these claw elements of the further claw carrier element runs at an angle to a main extension plane of the further claw carrier element. This advantageously allows further improving a holding force, with a perpendicular penetration depth that is as small as possible. Advantageously, as a result, the object can be squeezed in between the claw elements of the two movably supported claw carrier elements. The further claw carrier element may be realized at least substantially identically to the claw carrier element, and may in particular be arranged in a mirrored manner with respect to the claw carrier element. The further claw carrier element may be realized and/or arranged mirror-symmetrically with respect to the claw carrier element.

Alternatively, however, the further claw carrier element may be realized differently from the claw carrier element. It is conceivable that the further claw carrier element comprises claw elements that are similar to those of the claw carrier element and/or have the same shape and/or the same number of claw elements as the claw carrier element. Alternatively, however, the further claw carrier element may comprise claw elements of different kinds and/or different shapes and/or may comprise different numbers of claw elements than the claw carrier element. It is conceivable that claw elements of the two claw carrier elements are arranged offset with respect to one another, such that they are moved at least partially sideways past one another when the two claw carrier elements are moved towards one another. Alternatively or additionally, claw elements of the two claw carrier elements may also move directly towards one another when the two claw carrier elements are moved towards one another. In particular, the further claw carrier element is supported so as to be movable in an opposed direction to the claw carrier element. In particular, the further claw carrier element is movable towards the claw carrier element. In particular, two claw carrier elements, which are each supported so as to be translationally movable only parallel to a main extension plane of the claw carrier element, are movable towards one another along linear movement directions that are parallel to each other. In particular, two claw carrier elements, each supported so as to be rotationally movable only around a rotation axis that runs at least substantially perpendicular to a main extension plane of the claw carrier element, are rotatable in opposed directions of rotation, such that the claw elements of these claw carrier elements move at least substantially towards one another on circular paths or spiral paths. As a result, in each case the squeezing of the object between claw elements of the two claw carrier elements is advantageously achievable.

In this context, it is proposed that the further claw carrier element is supported movably, in particular supported movably in a coupled manner, relative to the claw carrier element in such a way that during or after a penetration of the claw elements of the two claw carrier elements into the object, a squeezing of an object material of the object can be brought about. In this way, an advantageously great holding force for the object is achievable, with a perpendicular penetration depth into the object that is as small as possible. In particular, the object material of the object is herein squeezed between the claw elements that have penetrated into the object. Preferably, the two claw carrier elements are coupled with each other (mechanically, for example via a transmission) in such a way that a movement of one of the two claw carrier elements causes an opposed movement of the other one of the two claw carrier elements. Alternatively to this, however, it is also conceivable that one of the claw carrier elements is realized so as to be movable and a further one of the claw carrier elements is realized so as to be rigid/immovable.

It is moreover proposed, in this context, that main extension planes of the claw elements of the further claw carrier element are in each case oblique in opposed directions relative to main extension planes of the claw elements of the claw carrier element. In this way, the squeezing of the object material between the claw elements can be optimized. In particular, a considerable amount of object material squeezing can be achieved per claw carrier element path covered. In particular, the main extension planes at least of a large portion of the claw elements of the further claw carrier element are oblique by the same angle with respect to the main extension plane of the further claw carrier element as at least a large portion of the main extension planes of the claw elements of the claw carrier element, wherein preferably, however, an angle direction of the respective main extension planes is reversed. In particular, the main extension planes at least of a large portion of the claw elements of the further claw carrier element intersect in a region that is situated in front of the surfaces of the claw carrier elements comprising the claw elements. In particular, the main extension planes at least of a large portion of the claw elements of the further claw carrier element intersect in a region facing towards the surfaces comprising the claw elements. In particular, (all) the claw directions of the claw elements are realized and/or arranged so as to face towards an imaginary middle plane of the holding and/or positioning unit that is perpendicular to the surfaces comprising the claw elements. Alternatively, however, it is also conceivable that at least a portion of the claw elements have claw directions that point away from the middle plane. By means of such claw elements, an expansion of the object material could be achieved instead of a squeezing. In particular, the surfaces of the claw carrier elements on which the claw elements are arranged or realized are at least substantially parallel to one another. “Substantially parallel” is here in particular to mean an orientation of a direction relative to a reference direction, in particular in a plane, wherein the direction differs from the reference direction by in particular less than 8°, advantageously less than 5° and particularly advantageously less than 2°.

It is further proposed that the claw carrier element and the further claw carrier element are free of mutual engagements and/or nesting. This advantageously allows achieving a simple construction.

Alternatively to this, it is proposed that the claw carrier element and the further claw carrier element are arranged so as to be nested in one another within the holding and/or positioning unit, preferably in a common surface plane formed by the surfaces of the claw carrier elements which respectively comprise the claw elements. In this way, advantageously a compact implementation is achievable. Advantageously, a particularly high squeezing force can be achieved, in particular already in the case of small movements of the claw carrier elements. Herein the claw carrier element and the further claw carrier element may be nested with each other linearly in a plane (for example like two intermeshing combs) or may be concentrically nested (for example two intermeshing rings) or even spirally nested (two intermeshing spirals) in a plane.

If at least a portion of the claw elements, preferably all of the claw elements, are realized so as to taper in a three-dimensionally pointed manner, it is advantageously possible to optimize the penetration into the surface of the object. Advantageously, the gripping process can be simplified and/or improved. The term “tapering in a three-dimensionally pointed manner” in particular describes a shape or structure which tapers in three dimensions (length, width and height) stepwise towards a point or an edge. This tapering may be symmetrical or asymmetrical, depending on the geometry of the shape. In particular, a cross section of an object that tapers in a three-dimensionally pointed manner becomes increasingly smaller until the object ends in an at least substantially punctiform tip. Alternatively, at least a portion of the claw elements, preferably all of the claw elements, could be realized so as to taper in a two-dimensionally pointed manner. In particular, a contour of an object that tapers in a two-dimensionally pointed manner becomes increasingly smaller until the object ends in an at least substantially punctiform edge (also referred to as a wedge shape).

If at least a portion of the claw elements that taper in a three-dimensionally pointed manner, preferably all of the claw elements, have at least two tips that are separate from one another, a claw effect can advantageously be improved. Advantageously, a total number of claw-like-acting elements per area can be increased. Advantageously, a simple construction is achievable. The two tips of a claw element could be straight/parallel to each other, or they could be directed slightly towards each other or slightly away from each other. If the two tips of a claw element are directed slightly towards each other or slightly away from each other, this advantageously allows at least partial absorption of shear forces that may occur during a slicing. In this way, advantageously a risk of a sideways-slipping of the object during a slicing could be reduced. The claw elements could in each case also have three or more than three tips that are separate from one another.

If a tip at least of a portion of the claw elements that taper in a three-dimensionally pointed manner is asymmetrically tapered in a three-dimensionally pointed manner and/or bent sideways, advantageously shear forces that may occur during a slicing can be at least partially absorbed. In this way, advantageously a risk of a sideways-slipping of the object during a slicing could be reduced.

It is also proposed that at least a portion of the claw elements, preferably all of the claw elements, are formed at least substantially in a sickle-like manner and/or at least substantially in a hook-like manner. In this way, in particular an advantageous claw effect is achievable. Advantageously, a considerable claw force can be achieved, with a perpendicular penetration depth that is as small as possible. A sickle-like shape is in particular a concavely curved geometry, which is typically characterized by an at least one-sided, continuous rounding with a pointed or narrow end. A hook-like shape is in particular characterized by an arc-shaped or curved geometry, in which a tip points to one side. In particular, at least a portion of the claw elements is formed in a cat-claw-like manner. A cat-claw-like shape is in particular a structure which tapers in a three-dimensionally pointed manner and is slightly to strongly bent, and which preferably serves both for hooking-in and for the selective penetration of materials. The cat-claw-like shape is used in the art, inter alia, also in surgical instruments.

Alternatively or additionally, it is proposed that at least a portion of the claw elements, preferably all of the claw elements, have at least substantially an oblique pyramid shape, preferably with a tip situated outside a pyramid base. In this way, in particular an advantageous claw effect is achievable. Advantageously, a considerable claw force can be achieved, with a perpendicular penetration depth that is as small as possible. An oblique pyramid in particular describes a pyramid shape whose tip (apex point) is not situated perpendicularly above a center point of the pyramid base, but is offset laterally with respect thereto. The pyramid base is preferably an N-gonal polygon, wherein preferably N=3, 4, 5, 6 or 7. However, other N values are likewise conceivable.

Alternatively or additionally, it is proposed that at least the claw elements, which are realized integrally, preferably monolithically, with the claw carrier element, are realized as tabs, in particular sheet metal tabs, which are bent out of the main extension plane of the claw carrier element. This advantageously allows achieving a simple and/or stable construction. In particular, the claw carrier element is realized at least in this case as a punched and bent sheet-metal part. The punched and bent sheet-metal part may be realized, for example, from a sheet metal having a thickness of 3 mm. However, other sheet metal thicknesses are of course likewise conceivable. In particular, the claw carrier element/s, preferably the claw elements of the claw carrier elements, is/are in this case realized in a planer-like manner/similar to a planer blade/similar to rasp teeth of a cheese grader. The claw elements that are realized in a planer-like manner are preferably wedge-shaped elevations, tapering in a pointed manner and having sharp, asymmetrical edges which, for example in a regular grid, are arranged on the claw carrier element so as to be inclined slightly forwards, and which preferably protrude from the surface of the claw carrier element.

In addition, it is proposed that adjacent to a basis of at least one of the claw elements, preferably of each claw element, an opening that penetrates the claw carrier element is realized, in particular for the removal of object residues of previously gripped objects. As a result, it is advantageously possible to achieve a high level of operational safety (low risk of clogging) and/or a high level of hygiene (few residues/self-cleaning). Moreover, advantageously a cleanability can be improved. In particular, each claw element shape described above may be equipped with the adjacent opening. It is possible that some claw elements or each claw element of one of the claw carrier elements are/is assigned an opening of their/its own. An opening or each opening of one of the claw carrier elements may extend across several claw elements and/or may be assigned to several claw elements. At least a portion of the openings or all of the openings of one of the claw carrier elements is/are enclosed all around/bounded all around by the surface of the claw carrier element. Preferably, the opening is arranged on a side of the basis of a claw element into which a claw direction of the claw element also points. In particular, the opening is arranged in the direction of a tip of the claw element. In particular, the opening is arranged in a region of the claw element, in particular of the basis of the claw element, in which the squeezing of the material of the object mainly takes place.

Beyond this, it is proposed that the industrial slicer device comprises a (mechanical) ejector unit configured to reliably detach the object, or a residue of the object that has been divided up by the separating unit, from the holding and/or positioning unit, preferably from the claw elements, by an impact movement. This advantageously allows attaining a high level of operational safety (low risk of clogging) and/or a high level of hygiene (few residues). The ejector unit is in particular configured to come into contact, via an ejector surface, with a surface of the object held by the claw elements, in particular with the surface of the object which has been pierced by the claw elements, and to push this surface away from the surface of the claw carrier element/s. The impact movement is preferably impact-like/jerky. The impact movement preferably results in a discarding, preferably a defined reproducible discarding, of the residue of the object from the holding and/or positioning unit. The impact movement is configured for a discarding/moving of the residue of the object into a container of the industrial slicer comprising the industrial slicer device, which is provided for this purpose.

In this context, it is moreover proposed that the ejector unit comprises at least one tappet element or several tappet elements which is/are extendable between the two claw carrier elements, and/or that the ejector unit comprises at least one tappet element or several tappet elements which is/are extendable and retractable between neighboring claw elements of the claw carrier element and/or above or below one of the claw carrier elements. In this way, advantageously effective discarding of the residue of the object is attainable, which preferably does not result in a breaking of the residue of the object. Advantageously, complete discarding of the residue of the object is thus achievable.

It is further proposed that the industrial slicer device comprises a gear unit, which is configured to couple deflection movements of the claw carrier element with extending and retracting movements of the tappet element or the tappet elements, in particular in such a way that a movement of the claw carrier element, which is configured to bring about an internal squeezing of the object and/or a fix holding of the object, results in a retraction of the tappet element or the tappet elements; and/or that a movement of the claw carrier element, which is configured to release an internal squeezing of the object and/or to bring about a releasing of the object, results in an extending of the tappet element or the tappet elements. In this way, advantageously a high level of operational safety is achievable. Moreover, a high number of cycles for the industrial slicer is advantageously attainable. The gear unit preferably comprises an interface for a connection of a drive unit that is configured to generate a kinetic energy for the translational and/or the rotational deflection movements of the claw carrier element in a motorized, pneumatic or hydraulic manner. The gear unit is preferably configured to translate the kinetic energy into movements of the claw carrier elements, and thus transmits a portion of the kinetic energy to the object. The generated squeezing of the object, in particular of the object material, exemplarily amounts to approximately 2 mm, but could also be more or less than that.

Moreover, it is proposed that the claw carrier element comprises at least one recess, in particular a circumferentially closed recess, which is configured for a pass-through of the tappet element or of several of the tappet elements. In this way, advantageously a particularly compact implementation of the industrial slicer device, in particular of the ejector unit and of the holding and/or positioning unit, is achievable.

Furthermore, an industrial slicer is proposed, comprising the separating unit for a dividing of objects into slices, and comprising a movement mechanism on which the industrial slicer device is arranged and which is at least configured to move the slicer device at least one-dimensionally/linearly towards the object for the purpose of creating a connection between the slicer device and the object. As a result, advantageous holding of the object relative to the separating unit is achievable. Advantageously, a yield, in particular a number of slices per sliced/cut object, can be maximized. It is advantageously possible, in particular in the case of food-product objects, to reduce waste of food products, in particular in that smaller/shorter end pieces can be obtained. The movement mechanism may comprise the drive unit. The movement mechanism may comprise a linear guide for a displacement of the industrial slicer device, in particular in the direction of the objects and/or of the separating unit. Alternatively, however, movement mechanisms for a multi-dimensional movement of the industrial slicer device are also conceivable. The industrial slicer may moreover comprise a conveyor system, such as for example a conveyor belt, by means of which the object is movable relative to the industrial slicer device and/or relative to the separating unit.

Moreover, a method is proposed for slicing objects, preferably for cutting food products—such as for example cheese products, sausage products, meat products, fish products or bakery products—into slices, by means of the industrial slicer, wherein the object is—at least during the dividing of the object into slices, in particular by the separating unit of the industrial slicer—held by the industrial slicer device, and/or is positioned, preferably relative to a separating unit, by the industrial slicer device. As a result, advantageous holding of the object relative to the separating unit is achievable. Advantageously, a slice yield per object can be maximized. Advantageously, waste of food products can be reduced.

The industrial slicer device according to the invention, the industrial slicer according to the invention and the method according to the invention shall here not be limited to the application and implementation described above. In particular, in order to fulfil a functionality that is described here, the industrial slicer device according to the invention, the industrial slicer according to the invention and the method according to the invention may have a number of individual elements, components and units that differs from a number given here.

### DRAWINGS

Further advantages will become apparent from the following description of the drawings. Seven exemplary embodiments of the invention are illustrated in the drawings. The drawings, the description and the claims contain numerous features in combination. Someone skilled in the art will purposefully also consider the features individually and will find further expedient combinations.

In the drawings:

FIG. 1 shows a schematic illustration of an industrial slicer with an industrial slicer device,

FIG. 2 shows a schematic perspective illustration of the industrial slicer device with a holding and/or positioning unit,

FIG. 3a shows a schematic side view of claw carrier elements of the industrial slicer device, with a plurality of claw elements,

FIG. 3b shows a schematic front view of a portion of one of the claw carrier elements,

FIG. 3c shows a schematic front view of a portion of the claw carrier element with a slightly bent claw element,

FIG. 4 shows a schematic flow chart of a method for a slicing of objects by means of the industrial slicer,

FIG. 5 shows a schematic perspective illustration of a first alternative industrial slicer device,

FIG. 6 shows a schematic side view of the first alternative industrial slicer device,

FIG. 7 shows a schematic perspective illustration of a second alternative industrial slicer device,

FIG. 8 shows a schematic perspective illustration of a third alternative industrial slicer device,

FIG. 9 shows a schematic side view of a fourth alternative industrial slicer device,

FIG. 10 shows a schematic front view of a fifth alternative industrial slicer device, and

FIG. 11 shows a schematic side view of a sixth alternative industrial slicer device,

### DESCRIPTION OF THE EXEMPLARY EMBODIMENTS

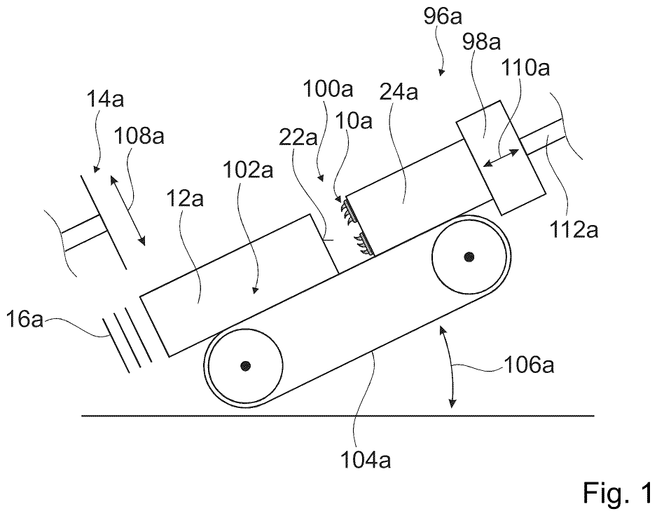

FIG. 1 schematically shows an industrial slicer 96a. The industrial slicer 96a is a food product slicer. The industrial slicer 96a is configured for dividing objects 12a, such as cheese product loaves, sausages, meat products, fish products or bakery product loaves, into slices 16a. The industrial slicer 96a comprises a receiving region 102a for receiving the object 12a. The receiving region 102a comprises, by way of example, a conveyor belt 104a for a displacement of the object 12a within the receiving region 102a. The receiving region 102a may be realized so as to be pivotable (cf. the double arrow 106a shown in FIG. 1). The industrial slicer 96a comprises a separating unit 14a. The separating unit 14a is configured for a dividing of the object 12a into slices 16a. The separating unit 14a comprises a knife for dividing the object 12a into the slices 16a. The separating unit 14a is movable towards the object 12a and away from the object 12a (cf. the double arrow 108a shown in FIG. 1). The industrial slicer 96a comprises an industrial slicer device 100a. The industrial slicer device 100a comprises a holding and/or positioning unit 10a. The holding and/or positioning unit 10a forms a collet. The collet is configured for a gripping/clamping-in of the object 12a. The holding and/or positioning unit 10a is configured for a holding and/or positioning of the object 12a to be sliced relative to the separating unit 14a. The industrial slicer 96a has a movement mechanism 98a. The industrial slicer device 100a is arranged on the movement mechanism 98a. The industrial slicer device 100a is fastened to the movement mechanism 98a. The movement mechanism 98a is configured to move the industrial slicer device 100a at least one-dimensionally and/or linearly. The movement mechanism 98a is at least configured to move the industrial slicer device 100a at least one-dimensionally and/or linearly towards the object 12a for the purpose of creating a (gripping) connection between the holding and/or positioning unit 10a of the slicer device 100a and the object 12a (cf. the double arrow 110a shown in FIG. 1). The movement mechanism 98a comprises a drive unit 112a. In addition to the generation of the linear movement of the industrial slicer device 100a, the drive unit 112a is configured to couple with an input of a gear unit 92a of the industrial slicer device 100a in order to thus drive internal movements of the industrial slicer device 100a, for example movements of components of the holding and/or positioning unit 10a, such as the claw carrier elements 26a, 64a of the holding and/or positioning unit 10a. The industrial slicer device 100a comprises the gear unit 92a. The gear unit 92a is interposed between the holding and/or positioning unit 10a and the movement mechanism 98a.

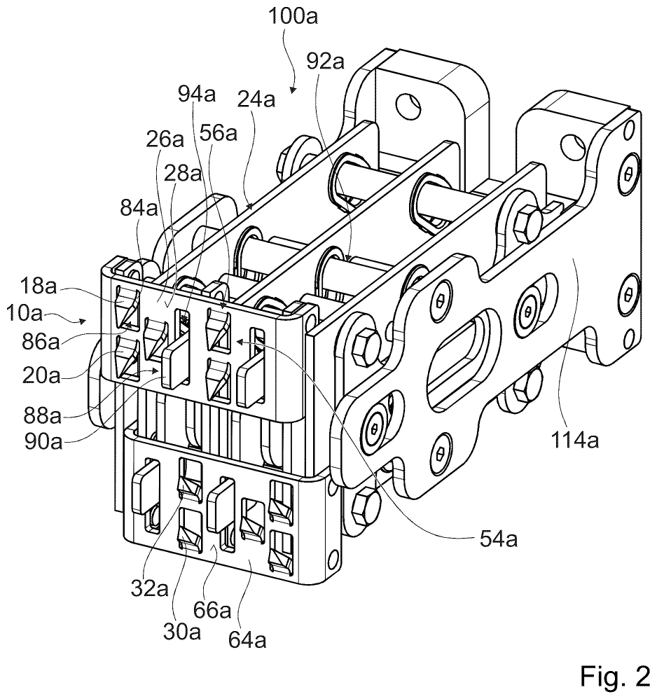

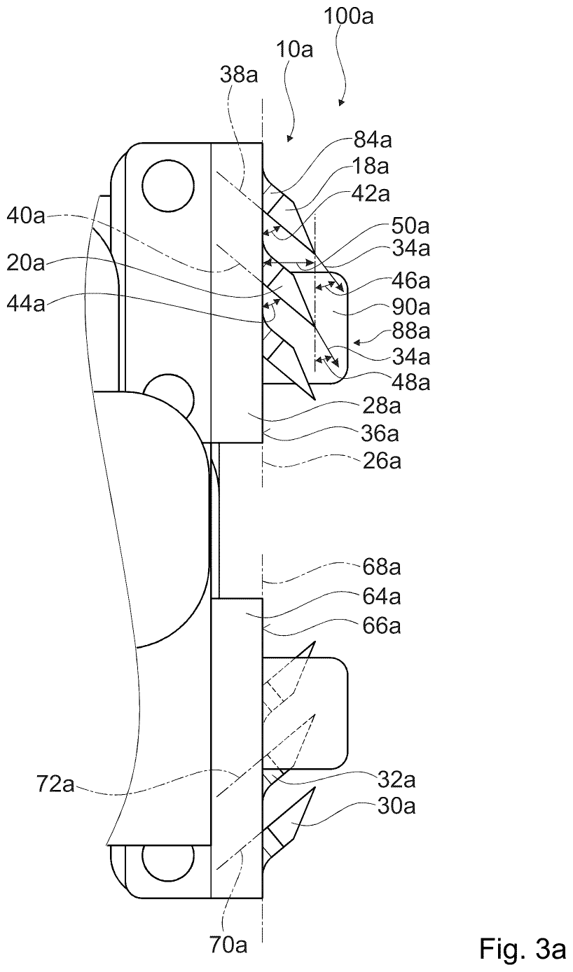

FIG. 2 shows a schematic perspective illustration of the industrial slicer device 100a. The industrial slicer device 100a is an industrial food-product slicer device. The holding and/or positioning unit 10a comprises a claw carrier element 26a. The holding and/or positioning unit 10a has a base 24a. The base 24a comprises the gear unit 92a. The base 24a comprises a structural framework 114a which accommodates the gear unit 92a. The claw carrier element 26a is translationally deflectable relative to the base 24a. The claw carrier element 26a is realized in a planar manner. The claw carrier element 26a is supported such that it is translationally movable only parallel to a main extension plane 36a (cf. FIG. 3a) of the claw carrier element 26a. The holding and/or positioning unit 10a comprises a further claw carrier element 64a. The further claw carrier element 64a is translationally deflectable relative to the base 24a. The translational deflections of the claw carrier elements 26a, 64a are generated by the gear unit 92a that is driven by the drive unit 112a. The further claw carrier element 64a is realized in a planar manner. The further claw carrier element 64a is supported such that it is translationally movable only parallel to the main extension plane 36a of the claw carrier element 26a. The claw carrier element 26a and the further claw carrier element 64a are free of mutual engagements and/or nesting. By way of example, the claw carrier element 26a or the claw carrier elements 26a, 64a together has/have an area of approximately 90 mm×90 mm, which is approximately equivalent to typical maximum sizes of objects 12a and slices 16a. However, larger or smaller dimensions of the claw carrier elements 26a, 64a are likewise conceivable.

Each of the claw carrier elements 26a, 64a comprises a plurality of claw elements 18a, 20a, 30a, 32a. The claw elements 18a, 20a, 30a, 32a are configured, in order to generate a claw force firmly holding the object 12a at the holding and/or positioning unit 10a, to pierce a surface 22a (cf. FIG. 1) of the object 12a and to penetrate into the object 12a. The claw elements 18a, 20a, 30a, 32a of each of the claw carrier elements 26a, 64a are respectively arranged in several rows 54a which are parallel to one another. The claw elements 18a, 20a, 30a, 32a of each of the claw carrier elements 26a, 64a are respectively arranged in several columns 56a which are parallel to one another. The claw carrier elements 26a, 64a each form the associated claw elements 18a, 20a, 30a, 32a integrally. The claw elements 18a, 20a, 30a, 32a are realized monolithically with the respective claw carrier element 26a, 64a. The claw elements 18a, 20a, 30a, 32a, which are realized integrally with the claw carrier elements 26a, 64a, are implemented by sheet metal tabs bent out of the respective main extension planes 36a, 68a (cf. FIG. 3a) of the respective claw carrier element 26a, 64a. The further claw carrier element 64a is supported movably relative to the claw carrier element 26a, in particular supported movably in a coupled manner, by the gear unit 92a, in such a way that during or after a penetration of the claw elements 18a, 20a, 30a, 32a of the two claw carrier elements 26a, 64a into the object 12a, a squeezing of an object material of the object 12a is brought about.

The industrial slicer device 100a comprises an ejector unit 88a. The ejector unit 88a is configured to reliably detach residues of objects 12a, which have been completely divided up by the separating unit 14a, from the holding and/or positioning unit 10a by an impact movement. The ejector unit 88a is configured to detach the residues of the objects 12a, which have been completely divided up by the separating unit 14a, from the claw elements 18a, 20a, 30a, 32a by the impact movement. The ejector unit 88a comprises several tappet elements 90a.

Alternatively, only one tappet element 90a could be provided. The tappet elements 90a are in each case extendable and retractable between adjacent claw elements 18a, 20a of one of the claw carrier elements 26a, 64a. For this purpose, the respective claw carrier element 26a, 64a has one circumferentially closed recess 94a per tappet element 90a. Each of the recesses 94a is configured for a pass-through of the respective associated tappet element 90a. Having passed through the respective recess 94a, the associated tappet element 90a protrudes substantially beyond the surface 28a, 66a of the respective claw carrier element 26a, 64a. The gear unit 92a is configured to couple a deflection movement of the claw carrier element 26a with extending and retracting movements of the tappet element 90a. The gear unit 92a couples the deflection movements of the claw carrier element 26a with the extending and retracting movements of the tappet element 90a in such a way that a movement of the claw carrier element 26a, which is configured to generate the internal squeezing of the object 12a and/or the holding of the object 12a, leads to a retraction of the tappet element 90a, such that the tappet element 90a in this state (closed state of the claw carrier elements 26a, 64a) does not protrude beyond the surface 28a, 66a of the respective claw carrier element 26a, 64a. The gear unit 92a couples the deflection movements of the claw carrier element 26a with the extending and retracting movements of the tappet element 90a in such a way that a movement of the claw carrier element 26a, which is configured to release the internal squeezing of the object 12a and/or to generate a release of the object 12a, leads to an extending of the tappet element 90a, such that the tappet element 90a in this state (opened state of the claw carrier elements 26a, 64a) protrudes beyond the surface 28a, 66a of the respective claw carrier element 26a, 64a and optionally, after the opening of the claw carrier elements 26a, 64a removes/displaces residues of the object 12a that are still adherent in the claw elements 18a, 20a, 30a, 32a.

FIG. 3a shows a schematic side view of the claw carrier elements 26a, 64a with several claw elements 18a, 20a. The claw elements 18a, 20a each have a claw direction 34a. The claw direction 34a of the claw elements 18a, 20a of the claw carrier element 26a runs at an angle to the main extension plane 36a of the claw carrier element 26a. Main extension planes 38a, 40a of the claw elements 18a, 20a of the claw carrier element 26a are in each case oblique with respect to the main extension plane 36a of the claw carrier element 26a. Angles 42a, 44a between the respective main extension planes 38a, 40a of the claw elements 18a, 20a of the claw carrier element 26a and the main extension plane 36a of the claw carrier element 26a are smaller than 60° and greater than 20° (preferably smaller than 60° and greater than 30°). Angles 46a, 48a between the claw directions 34a of the claw elements 18a, 20a of the claw carrier element 26a and the main extension plane 36a of the claw carrier element 26a are likewise smaller than 70° and greater than 20° (preferably smaller than 60° and greater than 30°). Main extension planes 70a, 72a of the claw elements 30a, 32a of the further claw carrier element 64a are in each case oblique in opposed directions to main extension planes 38a, 40a of the claw elements 18a, 20a of the claw carrier element 26a. The claw elements 18a, 20a have a perpendicular protrusion 50a beyond the surface 28a of the claw carrier element 26a, which surrounds the respective claw elements 18a, 20a. The perpendicular protrusion 50a of the claw elements 18a, 20a of the claw carrier element 26a is permanently 4 mm or more (preferably 6 mm or more). The perpendicular protrusion 50a of the claw elements 18a, 20a of the claw carrier element 26a is permanently 10 mm or less (preferably 8 mm or less). By way of example, in the figures all claw elements 18a, 20a, 30a, 32a always protrude approximately by equal distances beyond the surface 28a of the associated claw carrier element 26a, 64a that surrounds them. Alternatively, however, it is also conceivable that at least a portion of the claw elements 18a, 20a, 30a, 32a specifically protrude perpendicularly by a substantially smaller or substantially greater distance than other claw elements 18a, 20a, 30a, 32a.

FIG. 3b schematically shows a front view of a portion of the claw carrier element 26a with several claw elements 18a, 20a. The claw elements 18a, 20a are realized in a three-dimensionally tapering manner. Adjacent to a respective basis 84a of the claw elements 18a, 20a, 30a, 32a, which in particular establishes a connection with the associated claw carrier element 26a, 64a, the respective claw carrier element 26a, 64a has an opening 86a that penetrates the respective claw carrier element 26a, 64a. The opening 86a is configured for a removal of residues of previously gripped objects 12a. The claw elements 18a, 20a, 30a, 32a are formed, in particular when viewed together with the openings 86a, in a planer-like manner/in a manner like rasp teeth of a planer.

FIG. 3c schematically shows a front view of a portion of the claw carrier element 26a with a slightly bent claw element 52a. The slightly bent claw element 52a has a tip 78a which is asymmetrically tapered in a three-dimensionally pointed manner. The slightly bent claw element 52a has a tip 78a which is slightly bent sideways to the right (in a view from the front).

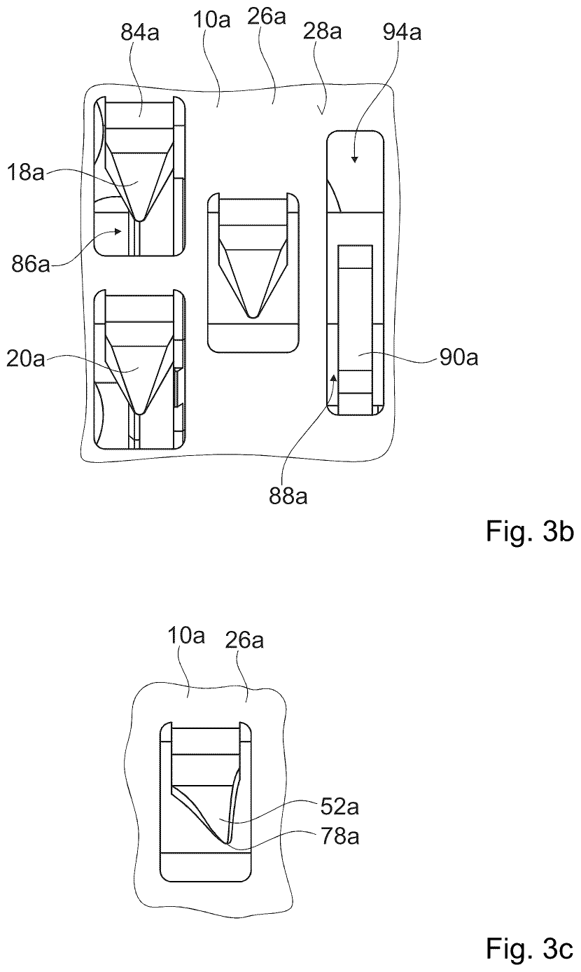

FIG. 4 shows a schematic flow chart of a method for a slicing of the objects 12a by means of the industrial slicer 96a. In at least one method step 116a, the object 12a is inserted into the receiving region 102a. In at least one method step 118a, the object 12a is moved by the conveyor belt 104a into an initial position. In at least one further method step 120a, the receiving region 102a is tilted along the direction of the double arrow 106a. In at least one further method step 122a, the industrial slicer device 100a with the holding and/or positioning unit 10a is moved towards the object 12a. In at least one further method step 124a, the claw elements 18a, 20a, 30a, 32a penetrate into the surface 22a of the object 12a and are moved translationally and/or rotationally in such a way that the object material of the object 12a is squeezed between the claw elements 18a, 20a, 30a, 32a that have penetrated. In at least one further method step 126a, the object 12a is processed by the separating unit 14a and is herein divided up into many slices 16a. During the dividing of the object 12a into the slices 16a by the separating unit 14a of the industrial slicer 96a, the object 12a is held by the holding and/or positioning unit 10a of the industrial slicer device 100a. In at least one further method step 128a, during the dividing of the object 12a in the state when held by the holding and/or positioning unit 10a, the object 12a is guided on in the direction of the separating unit 14a. In at least one further method step 130a, after a complete dividing up of the object 12a into the slices 16a, the residue of the object 12a is removed from the holding and/or positioning unit 10a by an extending of the tappet element 90a of the ejector unit 88a and is preferably ejected in a selective manner. Subsequently, a new object 12a can be brought into the receiving region 102a and the method described above starts again.

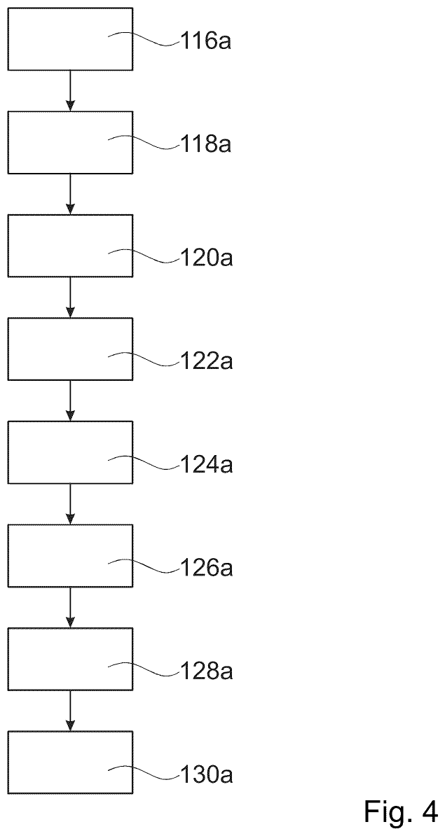

In FIGS. 5 to 11 six further exemplary embodiments of the invention are shown. The following descriptions and the drawings are essentially limited to the differences between the exemplary embodiments, wherein with respect to components having the same denomination, in particular with respect to components having the same reference numerals, in principle reference may also be made to the drawings and/or the description of the other exemplary embodiments, in particular of FIGS. 1 to 4. In order to distinguish between the exemplary embodiments, the letter a has been added to the reference numerals of the exemplary embodiment in FIGS. 1 to 4. In the exemplary embodiments of FIGS. 5 to 11, the letter a has been replaced by the letters b to g.

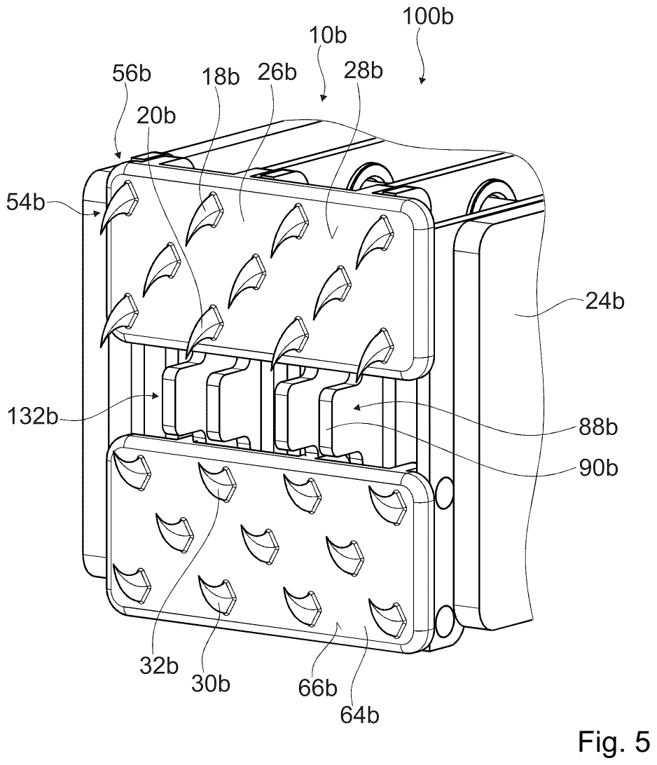

FIG. 5 shows a schematic perspective illustration of a first alternative industrial slicer device 100b. FIG. 6 shows a schematic side view of the first alternative industrial slicer device 100b. The first alternative industrial slicer device 100b comprises a first alternative holding and/or positioning unit 10b. The first alternative holding and/or positioning unit 10b comprises a claw carrier element 26b and a further claw carrier element 64b. The claw carrier elements 26b, 64b are supported such that they are translationally movable only parallel to a main extension plane 36b (cf. FIG. 6) of the respective claw carrier element 26b, 64b. The claw carrier element 26b and the further claw carrier element 64b are free of mutual engagements and/or nesting. Each of the claw carrier elements 26b, 64b comprises a plurality of first alternative claw elements 18b, 20b, 30b, 32b. The alternative claw elements 18b, 20b, 30b, 32b are arranged in a position-fixed and orientation-fixed manner on surfaces 28b of the claw carrier elements 26b, 64b. The alternative claw elements 18b, 20b, 30b, 32b are mounted on the surfaces 28b of the claw carrier elements 26b, 64b. The first alternative claw elements 18b, 20b, 30b, 32b are manufactured separately from the claw carrier elements 26b, 64b. The further claw carrier element 64b is supported movably relative to the claw carrier element 26b in such a way that during or after a penetration of the first alternative claw elements 18b, 20b, 30b, 32b into an object, a squeezing of an object material of the object 12b is brought about by a linear movement of the two claw carrier elements 26b, 64b towards one another.

The first alternative claw elements 18b, 20b, 30b, 32b are formed at least substantially in a sickle-like manner and/or at least substantially in a hook-like manner. The first alternative claw elements 18b, 20b, 30b, 32b are formed in a cat-claw-like manner. The first alternative industrial slicer device 100b comprises an ejector unit 88b. The ejector unit 88b is configured to reliably detach residues of objects 12b, which have been completely divided up by a separating unit, from the first alternative holding and/or positioning unit 10b by an impact movement. The ejector unit 88b is configured to detach the residues of the objects 12b, which have been completely divided up by the separating unit 14b, from the first alternative claw elements 18b, 20b, 30b, 32b by the impact movement. The ejector unit 88b comprises several tappet elements 90b. The tappet elements 90b are in each case extendable and retractable in an intermediate space 132b between the two claw carrier elements 26b, 64b.

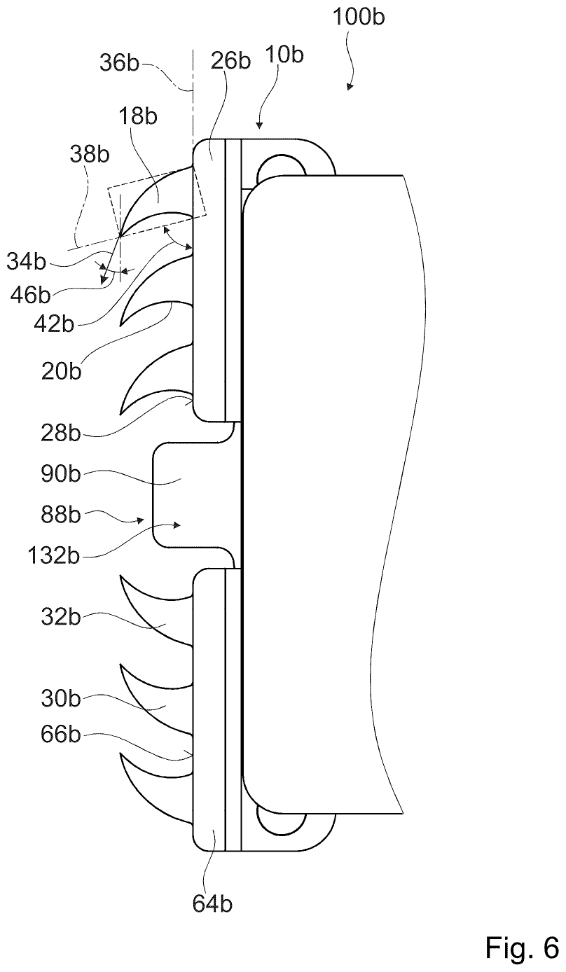

FIG. 7 shows a schematic perspective illustration of a second alternative industrial slicer device 100c. The second alternative industrial slicer device 100c comprises a second alternative holding and/or positioning unit 10c. The second alternative holding and/or positioning unit 10c comprises a claw carrier element 26c and a further claw carrier element 64c. The claw carrier elements 26c, 64c are supported such that they are translationally movable only parallel to a main extension plane 36c of the respective claw carrier element 26c, 64c. The claw carrier element 26c and the further claw carrier element 64c are arranged nested in one another within the second alternative holding and/or positioning unit 10c.

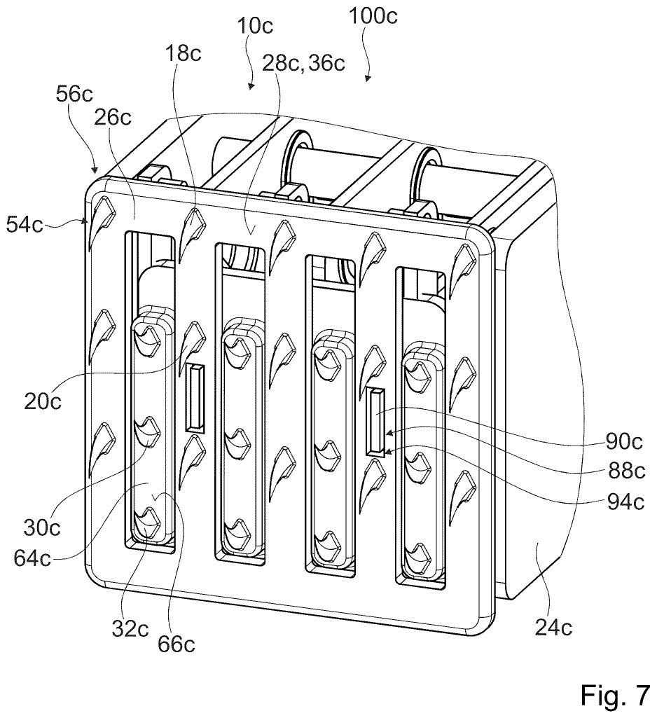

FIG. 8 shows a schematic perspective illustration of a third alternative industrial slicer device 100d. The third alternative industrial slicer device 100d comprises a third alternative holding and/or positioning unit 10d. The third alternative holding and/or positioning unit 10d comprises a claw carrier element 26d and a further claw carrier element 64d. The claw carrier elements 26d, 64d are each realized in a ring-shape. The claw carrier elements 26d, 64d are each rotationally movable. The claw carrier elements 26d, 64d are rotationally movable in opposed directions with respect to one another. The claw carrier elements 26d, 64d are supported such that they are rotationally movable only around a central rotation axis 62d that runs perpendicular to a main extension plane 36d of the respective claw carrier element 26d. The claw carrier element 26d and the further claw carrier element 64d are arranged nested in one another within the third alternative holding and/or positioning unit 10d. Each of the claw carrier elements 26d, 64d comprises a plurality of claw elements 18d, 20d, 30d, 32d, which are similar to the first alternative claw elements 18b, 20b, 30b, 32b of FIG. 5. The further claw carrier element 64d is supported so as to be movable relative to the claw carrier element 26d in such a way that during or after a penetration of the claw elements 18d, 20d, 30d, 32d into an object 12d, a squeezing of an object material of the object 12d is brought about by a rotational movement of the two claw carrier elements 26d, 64d towards one another. The claw elements 18d, 20d, 30d, 32d are respectively arranged on the claw carrier element 26d in ring patterns 58d which are concentric with respect to one another. The third alternative industrial slicer device 100d comprises an ejector unit 88d. The ejector unit 88d comprises a tappet element 90d. The tappet element 90d is arranged centrally in a center of the ring-shaped claw carrier elements 26d, 64d. The rotation axis 62d runs centrally through the tappet element 90d.

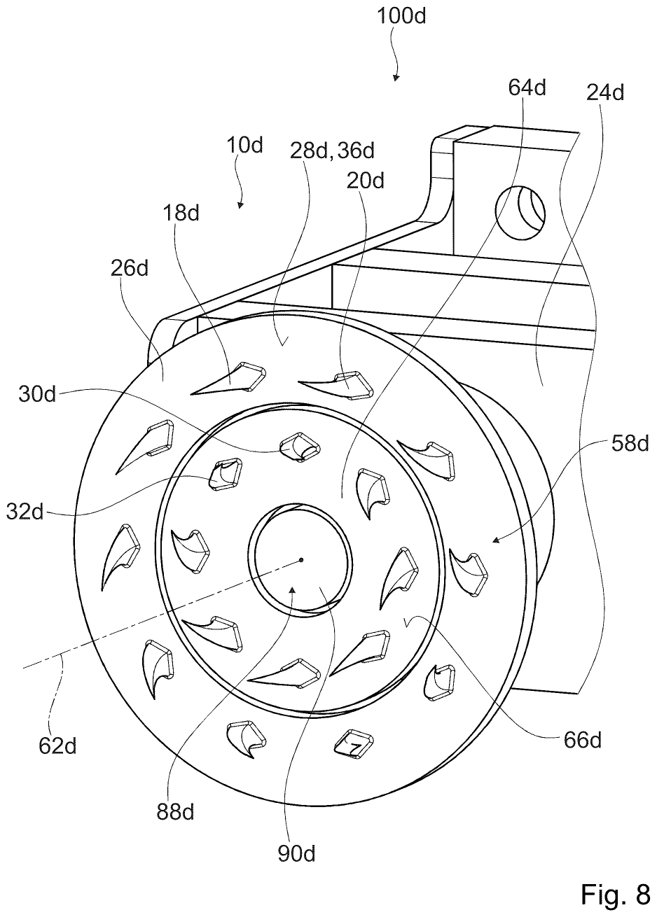

FIG. 9 shows a schematic side view of a fourth alternative industrial slicer device 100e. The fourth alternative industrial slicer device 100e comprises a fourth alternative holding and/or positioning unit 10e. The fourth alternative holding and/or positioning unit 10e comprises a claw carrier element 26e and a further claw carrier element 64e. The claw carrier elements 26e, 64e are each rotationally movable. The claw carrier elements 26e, 64e are rotationally movable in opposed directions with respect to one another. The claw carrier elements 26e, 64e are supported so as to be only rotationally movable around a pivot axis 60e, which runs at least parallel to a main extension plane 36e of the respective claw carrier element 26e, 64e. The claw carrier element 26e and the further claw carrier element 64e are free of mutual engagements and/or nesting.

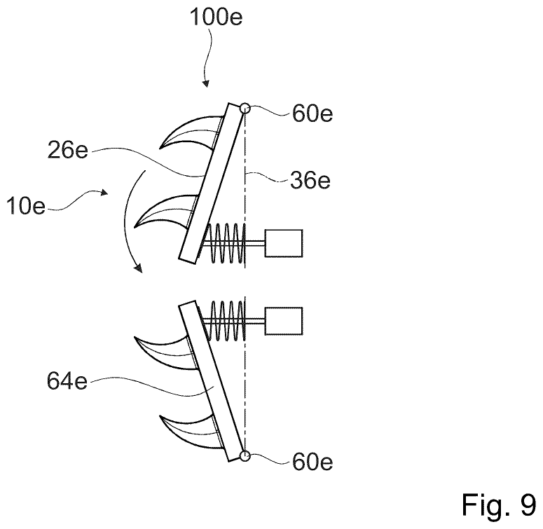

FIG. 10 shows a schematic front view of a fifth alternative industrial slicer device 100f. The fifth alternative industrial slicer device 100f comprises a fifth alternative holding and/or positioning unit 10f. The fifth alternative holding and/or positioning unit 10f comprises a claw carrier element 26f and a further claw carrier element 64f. The claw carrier elements 26f, 64f are each translationally movable. The claw carrier element 26f and the further claw carrier element 64f are arranged nested in one another within the third alternative holding and/or positioning unit 10f. Each of the claw carrier elements 26f, 64f comprises a plurality of second alternative claw elements 18f, 20f, 30f, 32f. The second alternative claw elements 18f, 20f, 30f, 32f each have two tips 74f, 76f, which are separate from one another. Each of the tips 74f, 76f tapers in a three-dimensionally pointed manner. The tips 74f, 76f of the claw elements 18f, 20f, 30f, 32f are in each case bent slightly sideways. The fifth alternative industrial slicer device 100f comprises an ejector unit 88f. The ejector unit 88f comprises a tappet element 90f. The tappet element 90f is extendable and retractable below the two claw carrier elements 26f, 64f. Alternatively, the tappet element 90f or a further tappet element 90f could also be extendable and retractable above the two claw carrier elements 26f, 64f.

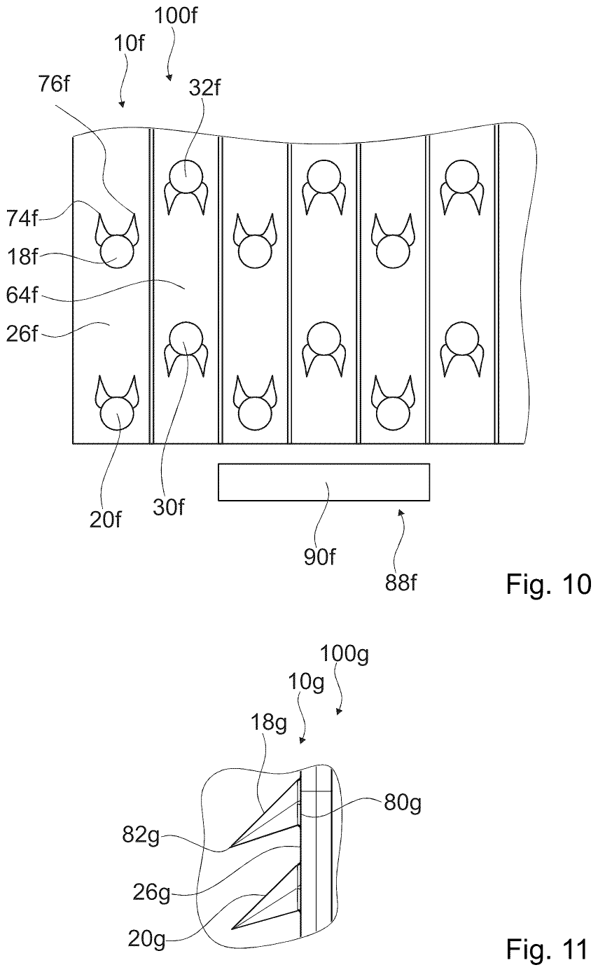

FIG. 11 shows a schematic side view of a sixth alternative industrial slicer device 100g. The sixth alternative industrial slicer device 100g comprises a sixth alternative holding and/or positioning unit 10g. The sixth alternative holding and/or positioning unit 10g comprises a claw carrier element 26g. The claw carrier element 26g comprises a plurality of third alternative claw elements 18g, 20g. The third alternative claw elements 18g, 20g have an oblique pyramid shape. The oblique pyramid is formed such that a straight line, which points perpendicularly from a pyramid tip 82g of the oblique pyramid in the direction of a pyramid base 80g of the oblique pyramid, is situated outside the pyramid base 80g.

### Reference Numerals

10 Holding and/or positioning unit
12 Object
14 Separating unit
16 Slice
18 Claw element
20 Claw element
22 Surface
24 Base
26 Claw carrier element
28 Surface
30 Claw element
32 Claw element
34 Claw direction
36 Main extension plane
38 Main extension plane
40 Main extension plane
42 Angle
44 Angle
46 Angle
48 Angle
50 Perpendicular protrusion
52 Slightly bent claw element
54 Row
56 Column
58 Ring pattern
60 Pivot axis
62 Rotation axis
64 Claw carrier element
66 Surface
68 Main extension plane
70 Main extension plane
72 Main extension plane
74 Tip
76 Tip
78 Tip
80 Pyramid base
82 Pyramid tip
84 Basis
86 Opening
88 Ejector unit
90 Tappet element
92 Gear unit
94 Recess
96 Industrial slicer
98 Movement mechanism
100 Industrial slicer device
102 Receiving region
104 Conveyor belt
106 Double arrow
108 Double arrow
110 Double arrow
112 Drive unit
114 Structural framework
116 Method step
118 Method step
120 Method step
122 Method step
124 Method step
126 Method step
128 Method step
130 Method step
132 Intermediate space

1. An industrial slicer device, comprising:
a holding and/or positioning unit at least for a holding and/or positioning of an object to be sliced relative to a separating unit that is capable of dividing the object into a plurality of slices,
wherein the holding and/or positioning unit comprises a plurality of claw elements configured, in order to generate a claw force holding the object at the holding and/or positioning unit, to pierce a surface of the object and to penetrate into the object,
wherein the holding and/or positioning unit comprises at least one claw carrier element, which is translationally and/or rotationally deflectable relative to a base of the holding and/or positioning unit, on the surface of which several of the claw elements are arranged and/or which forms several of the claw elements integrally, wherein a claw direction at least of a portion of these claw elements of the claw carrier element runs at an angle to a main extension plane of the claw carrier element.

2. The industrial slicer device according to claim 1, wherein at least one of the claw elements of the claw carrier element permanently protrudes by at least 4 mm perpendicularly beyond the surface of the claw carrier element that surrounds the claw element.

3. The industrial slicer device according to claim 1, wherein none of the claw elements of the claw carrier element protrudes by more than 10 mm perpendicularly beyond the surface of the claw carrier element that surrounds the claw element.

4. The industrial slicer device according to claim 1, wherein main extension planes of the claw elements of the claw carrier element are oblique with respect to the main extension plane of the claw carrier element.

5. The industrial slicer device according to claim 4, wherein angles between the main extension planes of the claw elements of the claw carrier element and the main extension plane of the claw carrier element, and/or angles between the claw directions of the claw elements of the claw carrier element and the main extension plane of the claw carrier element are smaller than 70°.

6. The industrial slicer device according to claim 4, wherein angles between the main extension planes of the claw elements of the claw carrier element and the main extension plane of the claw carrier element, and/or angles between the claw directions of the claw elements of the claw carrier element and the main extension plane of the claw carrier element are greater than 20°.

7. The industrial slicer device according to claim 1, wherein the claw elements are arranged on the claw carrier element in several rows which are parallel to one another, and/or in several columns which are parallel to one another.

8. The industrial slicer device according to claim 1, wherein the claw elements are arranged on the claw carrier element in a spiral pattern, in a ring pattern, or in several spiral patterns and/or ring patterns, which are preferably concentric with respect to one another.

9. The industrial slicer device according to claim 1, wherein the claw carrier element is supported such that it is translationally movable parallel to the main extension plane of the claw carrier element.

10. The industrial slicer device according to claim 1, wherein the claw carrier element is supported such that it is rotationally movable around a pivot axis that runs at least substantially parallel to the main extension plane of the claw carrier element.

11. The industrial slicer device according to claim 1, wherein the claw carrier element is supported such that it is rotationally movable around a rotation axis that runs at least substantially perpendicular to the main extension plane of the claw carrier element.

12. The industrial slicer device according to claim 1, wherein the holding and/or positioning unit comprises at least one further claw carrier element, which is translationally and/or rotationally deflectable relative to the base of the holding and/or positioning unit, on the surface of which several of the claw elements are arranged and/or which forms several of the claw elements integrally, wherein a claw direction at least of a portion of these claw elements of the further claw carrier element runs at an angle to a main extension plane of the further claw carrier element.

13. The industrial slicer device according to claim 12, wherein the further claw carrier element is supported movably relative to the claw carrier element in such a way that during or after a penetration of the claw elements of the two claw carrier elements into the object, a squeezing of an object material of the object can be brought about.

14. The industrial slicer device according to claim 12, wherein main extension planes of the claw elements of the further claw carrier element are in each case oblique in opposed directions relative to main extension planes of the claw elements of the claw carrier element.

15. The industrial slicer device according to claim 1, wherein at least a portion of the claw elements are realized so as to taper in a three-dimensionally pointed manner.

16. The industrial slicer device according to claim 1, wherein at least the claw elements, which are realized integrally with the claw carrier element, are realized as tabs which are bent out of the main extension plane of the claw carrier element.

17. The industrial slicer device according to claim 1, wherein adjacent to a basis of at least one of the claw elements, an opening that penetrates the claw carrier element is realized.

18. The industrial slicer device according to claim 1, further comprising an ejector unit configured to reliably detach the object, or a residue of the object that has been divided up by the separating unit, from the holding and/or positioning unit by an impact movement.

19. An industrial slicer, comprising a separating unit for a dividing of objects into slices, and comprising a movement mechanism on which an industrial slicer device according to claim 1 is arranged and which is at least configured, for the purpose of creating a connection between the slicer device and the object, to move the slicer device at least one-dimensionally/linearly towards the object.

20. A method for a slicing of objects by means of an industrial slicer, wherein at least during a dividing into slices, the object is held by, or is positioned relative to a separating unit by, an industrial slicer device according to claim 1.
